(19) United States
(12) Patent Application Publication
(10) Pub. No.: US 2019/0061053 A1
(43) Pub. Date: Feb. 28, 2019

(54) LASER BRAZING OF METAL WORKPIECES WITH RELATIVE MOVEMENT BETWEEN LASER BEAM AND FILLER WIRE

(71) Applicant: GM Global Technology Operations LLC, Detroit, MI (US)

(72) Inventors: David Yang, Shanghai (CN); Justin Wolsker, Shelby Township, MI (US); Blair Carlson, Ann Arbor, MI (US); Wu Tao, Tianmen (CN)

(21) Appl. No.: 15/685,290

(22) Filed: Aug. 24, 2017

(51) Int. Cl. B23K 26/08; B23K 26/244; B23K 26/10

(52) U.S. Cl. CPC B23K 26/0869; B23K 2203/10; B23K 26/10; B23K 26/244

(57) ABSTRACT

A method of laser brazing a metal workpiece assembly along a joint seam established between a first metal workpiece and a second metal workpiece involves advancing a laser beam along the joint seam while feeding a filler wire into the laser beam to melt a leading end of the filler wire, which is impinged by the laser beam, to produce and dispense molten filler material within and along the joint seam. The dispensed molten filler material solidifies behind the laser beam into a braze joint. Additionally, as part of the method, a position of a focal point of the laser beam relative to the leading end of the filler wire is repeatedly fluctuated during advancement of the laser beam along at least part of the joint seam.

### TECHNICAL FIELD

The technical field of this disclosure relates generally to laser brazing of metal workpieces and, more specifically, to a method for laser brazing metal workpieces with relative movement between the operating laser beam and the filler wire to enhance the quality of resultant the braze joint.

### INTRODUCTION

There are many instances in a manufacturing setting where two metal workpieces need to be joined along a shared interface. The automotive industry, for example, often needs to secure two prefabricated metal panels together when constructing certain vehicle component parts. Laser brazing is one widely-employed joining technique that is particularly suitable for joint seams that are located along a Class A surface of the part being fabricated. A Class A surface is typically a styled and non-planar show surface that is present on the visible exterior of an assembled vehicle or other finished product. Vehicle component parts that include joints seams that will eventually become part of a Class A surface include the roof, decklid, C-column, and trunk, to name but a few. The aesthetic appearance of any joints formed on Class A surfaces are often demanding and subject to strict optical requirements to facilitate the look of a smooth singular surface when painted. Laser brazing is routinely used and is an effective joining technique when both the aesthetic appearance and mechanical properties of the joint factor into the quality of the joint. Of course, laser brazing can be practiced in a variety of other circumstances and is not necessarily limited only to those applications in which the resultant braze joint is present along a Class A vehicle surface.

Laser brazing is a metal joining process in which a laser beam provides the energy needed to melt a consumable filler wire composed of a chosen braze material suitable in composition for the metal workpieces being joined. In practice, the filler wire is located at a joint seam established between the two metal workpieces, and a laser beam is directed at the joint seam so that a beam spot of the laser beam at least partially impinges a leading end of a filler wire, typically under the protection of a shielding gas. The filler wire absorbs the energy of the laser beam and melts into a molten filler material having a low enough viscosity that it can flow into the joint seam. The laser beam is advanced along the joint seam at a scheduled rate while the filler wire is continuously feed into the beam spot of the laser beam to maintain the impinged leading end and, thus, to continuously provide a source of molten flowable filler material during the forward advancement of the laser beam. The advancement of the laser beam along the joint seam in coordination with the continuously fed filler wire results in molten filler material being dispensed within and along the joint seem between the confronting surfaces of the metal workpieces that establish the joint seam.

The molten filler material placed within the joint seam in the wake of the forward advancement of the laser beam eventually solidifies into a braze joint that joins the workpieces together. The solidifying molten filler material wets the confronting surfaces of the workpieces prior to solidification such that the braze joint metallurgically bonds the workpieces surfaces together without melting either of the metal workpieces themselves. The resultant braze joint generally has a smooth top surface since the brazing process does not produce a keyhole or a turbulent melt pool, as is often the case with laser welding applications, and the relatively low-temperature nature of laser brazing produces only a minimal heat affected zone and therefore avoids thermally damaging the metal workpieces outboard of the joint seam. These physical and structural characteristics of the braze joint simplify subsequent processing of the braze joint area, such as smoothing (e.g., buffing, brushing, sanding, etc.) and painting, if necessary, without necessarily sacrificing the strength and mechanical properties of the braze joint, particularly if the joint is not load bearing.

In certain situations—particularly when the metal workpieces are steel workpieces or aluminum alloy workpieces—laser brazing can be susceptible to joining discrepancies that may adversely affect the mechanical properties of the braze joint, the aesthetic appearance of the braze joint, most notably at its top surface, or both. For example, when laser brazing together two steel workpieces coated with a zinc-based surface coating, such as zinc or a zinc-alloy, the heat associated with the laser brazing process may cause the zinc-based surface coating to boil in the vicinity of the joint seam, which can release high-pressure zinc into and around the molten filler material. The escaping high-pressure zinc can in turn lead to skip pores within the braze joint and can also spatter. Similar problems can be encountered when laser brazing together two aluminum alloy workpieces due to low boiling point alloy constituent elements, such as magnesium and zinc, that are often included in the aluminum alloy compositions. These low boiling point alloy constituents can be released as high-pressure vapor when exposed to the heat associated with the laser brazing process. Additionally, insufficient contact between the molten filler material and the confronting surfaces of the metal workpieces is a concern for both steel and aluminum workpieces. When there is insufficient contact between the molten filler material and the confronting surfaces of the metal workpieces along the joint seam, the braze joint that results may not have the expected strength and it may not fully bridge the joint seam, which is not a favorable outcome.

### SUMMARY OF THE DISCLOSURE

A method of laser brazing a metal workpiece assembly according to one version of the present disclosure may include several steps. In one step, a metal workpiece assembly is provided. The metal workpiece assembly includes a first metal workpiece and a second metal workpiece. The first and second metal workpieces establish a joint seam. In another step, a laser beam is advanced along the joint seam while feeding a filler wire into the laser beam to melt a leading end of the filler wire, which is impinged by the laser beam, to produce and dispense molten filler material within and along the joint seam as the laser beam is advanced along the joint seam. The molten filler material solidifies behind the laser beam into a braze joint. And, in yet another step, a position of a focal point of the laser beam is repeatedly fluctuated relative to the filler wire during advancement of the laser beam along at least part of the joint seam.

The method of the aforementioned version may be further defined. For example, the repeated fluctuation of the position of the focal point of the laser beam relative to the filler wire may include oscillating the focal point along a longitudinal beam axis of the laser beam to thereby alternately increase and decrease a focal distance of the laser beam during advancement of the laser beam along the joint seam. When this is the case, the focal point of the laser beam may be oscillated so that the focal distance of the laser beam is alternately increased and decreased over a total oscillation height between 0.1 mm and 1.0 mm at a frequency of 2 Hz to 1000 Hz.

As another example, the repeated fluctuation of the position of the focal point of the laser beam relative to the filler wire may include oscillating the filler wire along a direction parallel to an axial feeding direction of the filler wire to alternately increase and decrease a length of the leading end of the filler wire during advancement of the laser beam along the joint seam. When this is the case, the filler wire may be oscillated so that the length of the filler wire is alternately increased and decreased within a length range of 0.1 mm to 0.8 mm at a frequency of 3 Hz to 1000 Hz.

In still another example, the repeated fluctuation of the position of the focal point of the laser beam relative to the filler wire may include oscillating the filler wire along a direction transverse to an axial feeding direction of the filler wire to move the leading end of the filler wire back-and-forth across a centerline plane of the joint seam during advancement of the laser beam along the joint seam. When this is the case, the filler wire may be oscillated so that the leading end of the filler wire is moved across the centerline plane of the joint seam over a distance that ranges from 0.1 mm to 2.0 mm at a frequency of 2 Hz to 1500 Hz.

The first and second metal workpieces may be comprised of any laser brazable metal. For instance, in one embodiment, each of the first metal workpiece and the second metal workpiece may be a steel workpiece. Furthermore, when the first and second metal workpieces are steel workpieces, at least one of the first metal workpiece or the second metal workpiece may be a steel workpiece that comprises a surface coating comprised of a zinc-based coating material or an aluminum-based coating material. In another embodiment, each of the first metal workpiece and the second metal workpiece may be an aluminum alloy workpiece. Additionally, when the first and second metal workpieces are aluminum alloy workpieces, at least one of the first metal workpiece or the second metal workpiece may be an aluminum alloy workpiece that comprises a surface coating comprised of a refractory oxide material.

A method of laser brazing a metal workpiece assembly according to another version of the present disclosure may include several steps. In one step, a laser beam may be advanced along a joint seam established between a first metal workpiece and a second metal workpiece of a metal workpiece assembly. The laser beam has a focal point. In another step, a filler wire is fed into the laser beam as the laser beam is being advanced along the joint seam to melt a leading end of the filler wire, which is impinged by the laser beam, to produce and dispense molten filler material within and along the joint seam. In still another step, a position of the focal point of the laser beam is repeatedly fluctuated relative to the filler wire during advancement of the laser beam along at least part of the joint seam. The molten filler material solidifies behind the laser beam into a braze joint that metallurgically bonds the first and second metal workpieces together.

The method of the aforementioned version may be further defined. For example, in one embodiment, the repeated fluctuation of the position of the focal point of the laser beam relative to the filler wire may include oscillating the focal point along a longitudinal beam axis of the laser beam to thereby alternately increase and decrease a focal distance of the laser beam during advancement of the laser beam along the joint seam. In another embodiment, the repeated fluctuation of the position of the focal point of the laser beam relative to the filler wire may include oscillating the filler wire along a direction parallel to an axial feeding direction of the filler wire to alternately increase and decrease a length of the leading end of the filler wire during advancement of the laser beam along the joint seam. In still another embodiment, the repeated fluctuation of the position of the focal point of the laser beam relative to the filler wire may include oscillating the filler wire along a direction transverse to an axial feeding direction of the filler wire to move the leading end of the filler wire back-and-forth across a centerline plane of the joint seam during advancement of the laser beam along the joint seam.

The first and second metal workpieces may be comprised of any laser brazable metal. For instance, each of the first metal workpiece and the second metal workpiece may be a steel workpiece. Furthermore, when the first and second metal workpieces are steel workpieces, at least one of the first metal workpiece or the second metal workpiece may be a steel workpiece that comprises a surface coating comprised of a zinc-based coating material. In another embodiment, each of the first metal workpiece and the second metal workpiece may be an aluminum alloy workpiece. Additionally, when the first and second metal workpieces are aluminum alloy workpieces, at least one of the first metal workpiece or the second metal workpiece may be an aluminum alloy workpiece that comprises a surface coating comprised of a refractory oxide material.

A method of laser brazing a metal workpiece assembly according to yet version of the present disclosure may include several steps. In one step, a laser beam may be advanced along a joint seam established between a first metal workpiece and a second metal workpiece of a metal workpiece assembly. The laser beam has a focal point. In another step, a filler wire is fed into the laser beam as the laser beam is being advanced along the joint seam to melt a leading end of the filler wire, which is impinged by the laser beam, to produce and dispense molten filler material within and along the joint seam. This molten filler material solidifies behind the laser beam into a braze joint that metallurgically bonds the first and second metal workpieces together. In yet another step, the focal point of the laser beam is oscillated along a longitudinal beam axis of the laser beam to thereby alternately increase and decrease a focal distance of the laser beam during advancement of the laser beam along at least part of the joint seam. In still another step, the filler wire is oscillated along a direction transverse to an axial feeding direction of the filler wire to move the leading end of the filler wire back-and-forth across a centerline plane of the joint seam during advancement of the laser beam along at least part of the joint seam at the same time the focal point of the laser beam is being oscillated along the longitudinal beam axis of the laser beam.

### BRIEF DESCRIPTION OF THE DRAWINGS

FIG. 1 is a top perspective view of a metal workpiece assembly, which includes a first metal workpiece and a second metal workpiece, being laser brazed together along a joint seam by a laser brazing apparatus that includes a laser brazing optical focus head, a wire feeder, and a shield gas nozzle;

FIG. 2 is a cross-sectional view of the metal workpiece assembly and portions of the laser brazing apparatus taken along section line 2-2 of FIG. 1;

FIG. 3 is a cross-sectional view of the metal workpiece assembly and portions of the laser brazing apparatus taken down the joint seam along section line 3-3 of FIG. 1;

FIG. 4 is a schematic illustration of the laser brazing optical focusing head depicted generally in the laser brazing apparatus of FIG. 1;

FIG. 5 is a magnified cross-sectional view of the metal workpiece assembly and portions of the laser brazing apparatus taken along the same vantage of section line 3-3 of FIG. 1;

FIG. 6 is a magnified cross-sectional view of the metal workpiece assembly and the filler wire taken down the joint seam along the same vantage of section line 2-2 of FIG. 1; and

FIG. 7 is a magnified cross-sectional view of the metal workpiece assembly taken down the joint seam along the same vantage of section line 2-2 of FIG. 1.

### DETAILED DESCRIPTION

A method of laser brazing two metal workpieces together along a joint seam established between abutting metal workpieces is disclosed. The method involves engendering relative movement between an advancing laser beam and filler wire that is continuously fed into the laser beam along a forward feeding direction to dispense molten filler material along the joint seam. In particular, the aforementioned relative movement between the laser beam and the filler wire may be implemented by repeatedly fluctuating the position of a focal point of the laser beam relative to a leading end of the filler wire. Such repeated fluctuation can be achieved by executing one or more of the following actions: (1) oscillating the focal point of the laser beam along a longitudinal beam axis with respect to the metal workpiece assembly; (2) oscillating the filler wire along a direction parallel to an axial feeding direction of the filler wire; or (3) oscillating the filler wire in a direction transverse to the axial feeding direction of the filler wire. By provoking relative movement between the laser beam and the filler wire as the laser beam is advanced along the joint seam, the heat input to the filler wire can be better controlled and and/or the flow behavior of the molten filler material within the joint seam can be enhanced to ensure good contact between the confronting surfaces of the metal workpieces.

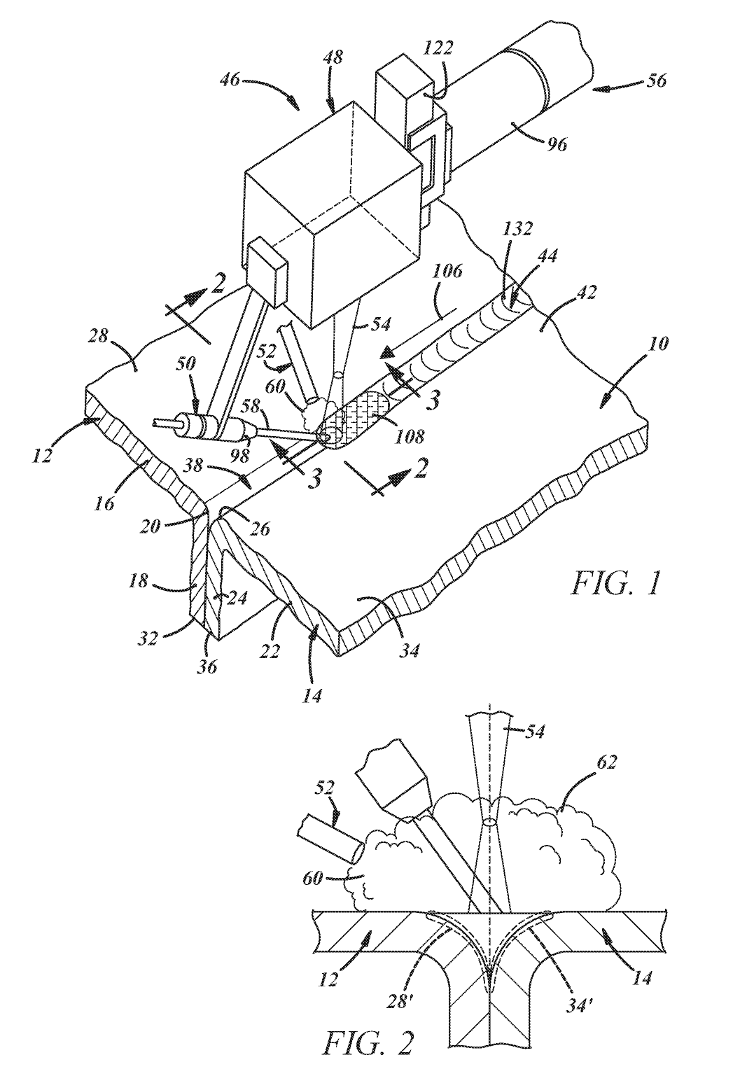

Referring now to FIG. 1, a metal workpiece assembly 10 is shown that includes a first metal workpiece 12 and a second metal workpiece 14. The first metal workpiece 12 includes a first main panel portion 16 and a first flange portion 18 that bends away from the first main panel portion 16 along a first bend line 20. Similarly, the second metal workpiece 14 includes a second main panel portion 22 and a second flange portion 24 that bends away from the second main panel portion 22 along a second bend line 26. The bend angle of each of the first and second flange portions 18, 24 is preferably substantially perpendicular, as shown, although other angles are certainly possible. The first metal workpiece 12 has a first top surface 28 that spans the first main panel portion 16 and extends over the first bend line 20 to a terminal edge 32 of the first flange portion 16 and, likewise, the second metal workpiece 14 has a second top surface 34 that spans the second main panel portion 22 and extends over the second bend line 26 to a terminal edge 36 of the second flange portion 24. Each of the first and second metal workpieces has a thickness that ranges from 2 mm to 6 mm or, more narrowly, from 2.5 mm to 4.0 mm.

The first and second metal workpieces 12, 14 are brought and assembled together by suitable fixturing equipment so that their flange portions 18, 24 abut. The assembled metal workpieces 12, 14 establish a joint seam 38 that, as shown best in FIGS. 2 and 6-7, is defined by confronting regions 28′, 34′ of the first and second top surfaces 28, 34 of the first and second metal workpieces 12, 14. The confronting regions 28′, 34′ of the first and second top surfaces 28, 34 are those portions of the top surfaces 28, 34 that are separate and face each other along the first and second flange portions 18, 24 up through the first and second bending lines 20, 26. To that end, the joint seam 38 is an elongated channel that has a centerline plane 40 (FIG. 6) and is generally funnel-shaped in cross-section. In its assembled state, the metal workpiece assembly 10 makes the first and second top surfaces 28, 34 of the first and second metal workpieces 12, 14 available for laser brazing to unify the top surfaces 28, 34 across the joint seam 38 into a conjoint upper surface 42 of the metal workpiece assembly 10. The conjoint exposed upper surface 42 of the metal workpiece assembly 10 may, in the realm of vehicle manufacturing, be a Class A show surface or some other interior or exterior surface of a vehicle.

The first and second metal workpieces 12, 14 may be composed of a variety of metals that are conducive to laser brazing. For example, both of the first and second metal workpieces 12, 14 may be steel workpieces, or in another example, both of the first and second metal workpieces 12, 14 may be aluminum alloy workpieces. Whether composed of steel or an aluminum alloy, each of the first and second metal workpieces 12, 14 may be coated or uncoated. The first and second metal workpieces 12, 14—whatever their composition—are preferably wrought sheet metal layers but may take on other forms including extrusions or castings. Additionally, one or both of the first and second metal workpieces 12, 14 may be prefabricated prior to laser brazing by any suitable forming technique including but not limited to stamping, pressing, drawing, quick plastic forming (QPF), and superplastic forming (SPF). Of course, in an alternative approach, one or both of the first and second metal workpieces 12, 14 may be formed into its final shape following laser brazing. The term “workpiece” as used herein in conjunction with the first and second metal workpieces 12, 14 thus encompasses a variety of compositions, including steel and aluminum alloy, both coated and uncoated, in any form (wrought sheet metal layer, extrusion, casting, etc.) that can accommodate laser brazing.

If the first and second metal workpieces 12, 14 are steel workpieces, each of the metal workpieces 12, 14 may be composed of a coated or uncoated steel substrate. Several notable steel substrates that may be employed include low carbon (mild) steel, interstitial-free (IF) steel, bake-hardenable steel, high-strength low-alloy (HSLA) steel, dual-phase (DP) steel, complex-phase (CP) steel, martensitic (MART) steel, transformation induced plasticity (TRIP) steel, twining induced plasticity (TWIP) steel, and boron steel such as when the workpiece(s) 12, 14 include press-hardened steel (PHS). The steel substrates of the first and second metal workpieces 12, 14 may be the same or different. And, if a coating is present to either or both of the steel substrates of the first and second metal workpieces 12, 14, that coating is preferably a zinc-based coating material or an aluminum-based coating material. Some examples of a zinc-based coating material include zinc or a zinc alloy such as a zinc-nickel alloy or a zinc-iron alloy. Such coating materials may be applied by hot-dip galvanizing (hot-dip galvanized zinc coating), electrogalvanizing (electrogalvanized zinc coating), galvannealing (galvanneal zinc-iron alloy), or electrodepositing (zinc-iron alloy or zinc-nickel alloy). Some examples of an aluminum-based coating material include aluminum, an aluminum-silicon alloy, an aluminum-zinc alloy, and an aluminum-magnesium alloy. These aluminum-based coating materials may be applied by dip coating.

If the first and second metal workpieces 12, 14 are aluminum alloy workpieces, each of the metal workpieces 12, 14 may be composed of a coated or uncoated aluminum alloy substrate that includes at least 85 wt % aluminum. Several notable aluminum alloys that may be employed include an aluminum-magnesium alloy, an aluminum-silicon alloy, an aluminum-magnesium-silicon alloy, or an aluminum-zinc alloy. Some more specific kinds of aluminum alloys that can be used include AA5182 and AA5754 aluminum-magnesium alloy, AA6011 and AA6022 aluminum-magnesium-silicon alloy, AA7003 and AA7055 aluminum-zinc alloy, and Al-10Si-Mg aluminum die casting alloy. The first and/or second aluminum base layers 36, 38 may be employed in a variety of tempers including annealed (O), strain hardened (H), and solution heat treated (T). The aluminum alloy substrates of the first and second metal workpieces 12, 14 may be the same or different. And, if a coating is present on either or both of the aluminum alloy substrates of the first and second metal workpieces 12, 14, that coating is usually a refractory oxide materail comprised of aluminum oxide compounds that forms passively when fresh aluminum is exposed to atmospheric air or some other oxygen-containing medium and/or during manufacturing operations (e.g., mill scale) or otherwise. Alternatively, the coating may be a metallic coating comprised of zinc or tin, or it may be a metal oxide conversion coating comprised of oxides of titanium, zirconium, chromium, or silicon as disclosed in U.S. Patent Application No. US2014/0360986.

Referring now to FIGS. 1-6, a method of laser brazing the metal workpiece assembly 10 to metallurgically join the first and second metal workpieces 12, 14 together is illustrated in accordance with certain practices fo the disclosure. The method includes providing the metal workpiece assembly 10 so that the joint seam 38 is established between the first and second metal workpieces 12, 14. This may involve, as mentioned before, bringing the flange portions 18, 24 of the first and second metal workpieces 12, 14 together into interfacial abutment with the use of suitable fixturing equipment. A braze joint 44 is then deposited within and along the joint seam 38. The deposition of the braze joint 44 is performed by a laser brazing apparatus 46 that includes a laser brazing optical focus head 48, a wire feeder 50, and a shielding gas nozzle 52. The laser brazing optical focus head 48 focuses and directs a laser beam 54 at the metal workpiece assembly 10 while a being carried along the joint seam 38 by a robot 56 (partially show). At the same time, the wire feeder 50 feeds a filler wire 58 into the laser beam 54 and the shielding gas nozzle 52 emits a shielding gas 60 towards the joint seam 38 to produce a shielding gas zone 62.

As shown generically in FIG. 4, the laser brazing optical focus head 48 includes a body 64 that houses a collimator 66 and a focusing element 68. An end 70 of a fiber optic cable 72 is received in the body 64 and delivers a diverging conical laser beam 74 that originates in a laser beam generator (not shown). The diverging conical laser beam 74 is transformed by the collimator 66 into a collimated laser beam 76 having a constant beam diameter. The collimator 66 may be a curved lens such as a parabolic or spherical lens through which the diverging conical laser beam 74 can pass. After departing the collimator 66, the collimated laser beam 76 is deflected by an intermediate mirror 78 and delivered to the focusing element 68. The focusing elements focuses the collimated laser beam 76 into the laser beam 54 that is transmitted by the laser brazing optical focus head 48 towards the metal workpiece assembly 10 and ultimately impinges the filler wire 58. The focusing element 68 narrows the beam diameter of the laser beam 54 to a focal point or “waist” 80 that preferably has a diameter ranging from 0.5 mm to 4.0 mm. Like the collimator 66, the focusing element 68 may be curved lens such as a parabolic or spherical lens through which the collimated laser beam 76 can pass. Of course, the the laser brazing optical focus head 48 may be designed to use mirrors as the collimator 66 and focusing element 68, instead of lenses, among other possible variations.

The laser beam 54 exits the laser brazing optical focus head 48 after interacting with the focusing element 68 and propagates forward along a longitudinal beam axis 82. The laser beam 54 may be a solid-state laser or a gas laser. Some notable solid-state lasers that may be used are a fiber laser, a disk laser, a direct diode laser, and a Nd:YAG laser, and a notable gas laser that may be used is a CO₂ laser, although other types of lasers may certainly be used. The laser beam 54 is preferably fiber delivered (to the extent it is not generated in the fiber itself) to the laser brazing optical focus head 48 by a fiber optic cable. Additionally, the power level of the laser beam 54 may be tailored to deliver enough energy to the joint seam 38 and the filler wire 58 to facilitate melting of the filler wire 58 without melting either of the first or second metal workpieces 12, 14 to the extent that a penetrating melt pool is formed. To that end, the power level of the laser beam 54 preferably ranges from 1.0 kW to 10 kW or, more narrowly, from 2.5 kW to 6.0 kW when laser brazing steel workpieces and from 2.0 kW to 6.0 kW when laser brazing aluminum alloy workpieces. Laser generators that can generate the various solid-state and gas lasers discussed above as well as other variations are commercially available. Other solid-state and gas laser beams not specifically mentioned here may of course be used.

The laser beam 54 has a focal length 84 and a focal distance 86. The focal length 84 is the distance between the focusing element 68 where beam narrowing is initiated and the focal point 80 of the laser beam 54. This distance may range anywhere from 100 mm to 400 mm or, more narrowly, from 200 mm to 300 mm. The focal distance 86 is the distance between the focal point 80 and a beam spot 88 of the laser beam 54 along the longitudinal beam axis 82 of the laser beam 54. The beam spot 88 is the projected sectional area of the laser beam 54 at a plane 90 that extends across the joint seam 38 and intersects the transitions between the the main panel portions 16, 22 and their respective bend lines 20, 26, as shown in FIG. 7. The focal distance 86 of the laser beam 54 may range anywhere from 0 mm (focal point is located at the plane 90) to 10 mm or, more narrowly, from 0 mm to 5 mm, either above or below the plane 90 that extends across the joint seam 38. Indeed, as will be more fully explained below, the focal distance 86 of the laser beam 54 may be varied within this range during laser brazing as a result of oscillating the focal point 80 along the longitudinal beam axis 82, which in turn may vary the focal length 84 of the laser beam 54 to a corresponding yet opposite extent.

The laser brazing optical focusing head 48 may include other associated components and equipment. When the laser brazing optical focus head 48 is operational and the laser beam 54 is being directed towards the metal workpiece assembly 10, cooling functionality installed in the optical focus head 48 may be initiated to help ensure the collimator 66 and the focusing element 68 do not overheat. The laser brazing optical focus head 48 may also include visual monitoring equipment 92, such as a camera with a CCTV lens, having a line of sight down the longitudinal beam axis 82 of the laser beam 54 as well as other associated components and equipment. For instance, as shown in FIG. 4, the laser brazing optical focus head 48 may include an adaptive focusing optic assembly 94 positioned upstream of the focusing element 68 that can vary the focal point 82 of the laser beam 54 on command. In one embodiment, as shown, the adaptive focusing optic assembly 94 may be a sleeve structure that slidingly receives the collimator 66 and can responsively change the position of the collimator 66 by sliding the collimator 66 forward to lengthen the diverging conical laser beam 74 or rearward to shorten the diverging conical laser beam 74 with the aid of a high-speed actuator such as a servomotor or a piezoelectric actuator. Such forward and rearward movement of the collimator 66 increases and decreases the diameter of the collimated later beam 76, respectively, which affects the focal length 84 and thus the focal distance 86 of the laser beam 54. The laser brazing optical focusing head 48 shown schematically in FIGS. 1 and 4 and described above can be obtained commercially.

The robot 56 that carries the laser brazing optical focusing head 48 is operable to move the laser brazing optical focusing head 48 within the space above the metal workpiece assembly 10 in order to advance the laser beam 54 relative to assembly 10 and along the joint seam 38. In particular, the robot 56 includes a robot arm 96 that connects to and supports the laser brazing optical focusing head 48. The robot 56 including the robot arm 96 are constructed with rotary, swivel, hinge, and/or other types of junctions that permit precise and programmable robotic movement of the laser brazing optical focusing head 48 in multiple axes with the aid of computer-implemented control systems. Because the longitudinal beam axis 82 of the laser beam 54 is fixed in relation to the focusing element 68, the laser beam 54 and, in particular, the beam spot 88 of the laser beam 54, may thus be advanced along the joint seam 38 by operating the robot 56 to convey the laser brazing optical focusing head 48 along a corresponding pathway above the metal workpiece assembly 10. Indeed, the travel speed of the laser beam 24 along the joint seam 38 is equal to the speed at which the laser brazing optical focusing head 48 is being moved relative to the metal workpiece assembly 10. The implemented travel speed of the laser beam 54 for laser brazing according to practices of the disclosed method preferably range from 3.0 m/min to 10.0 m/min.

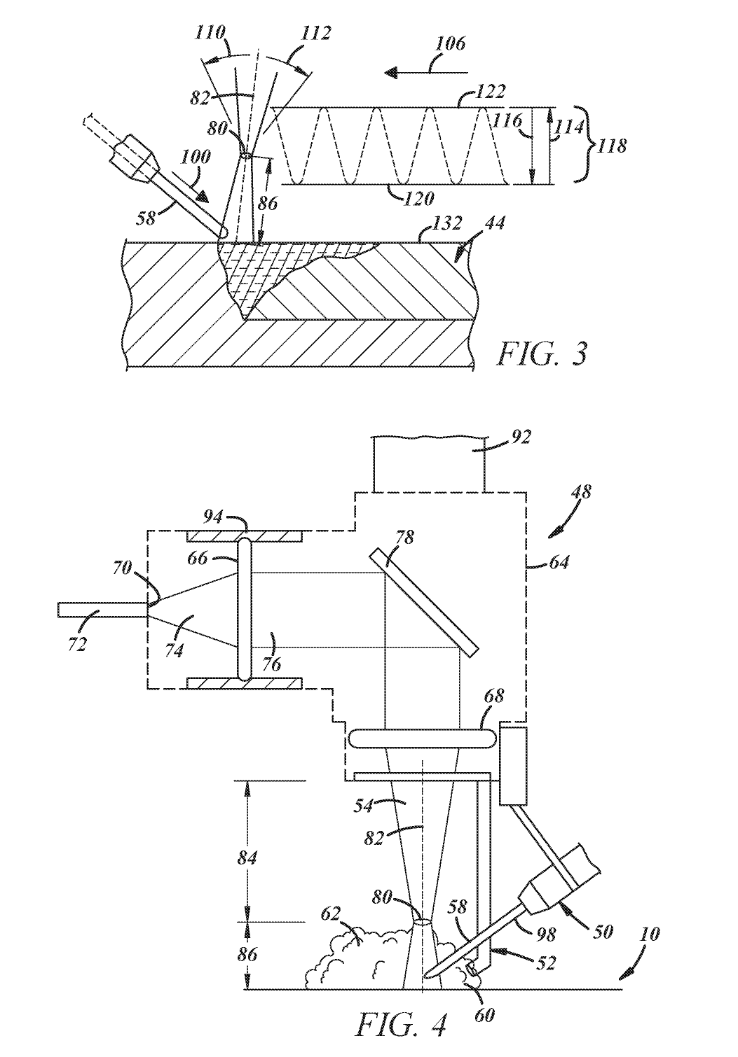

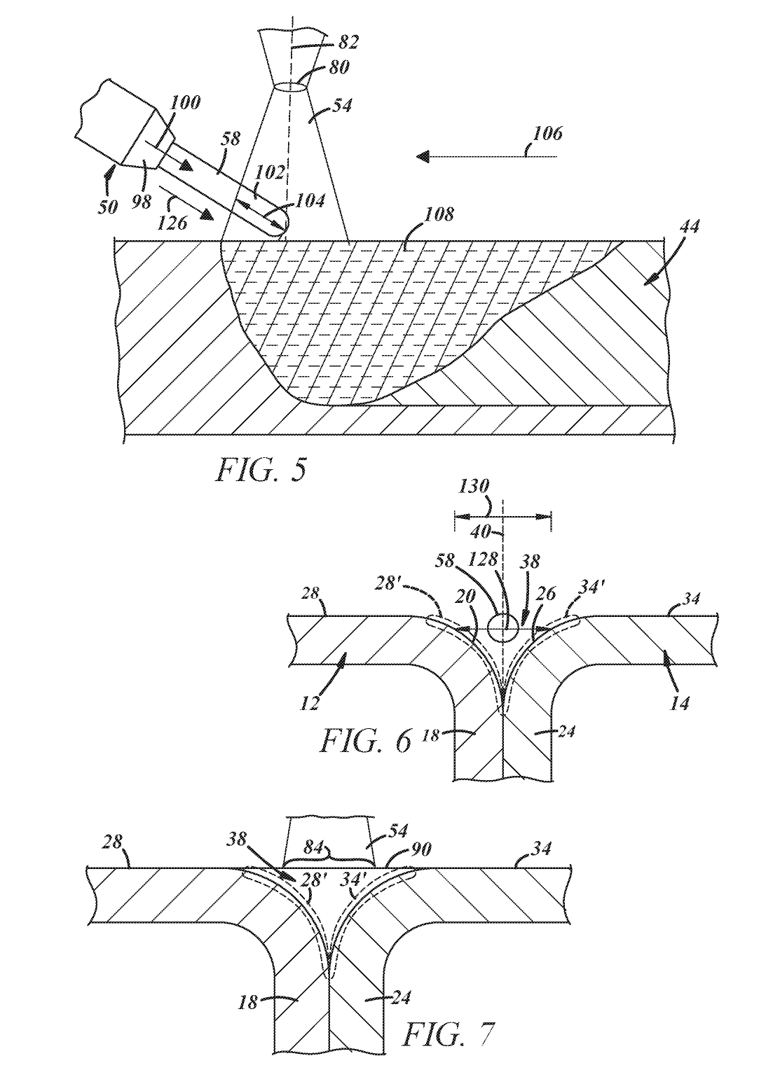

The wire feeder 50 and the shielding gas nozzle 52 may be connected to the laser brazing optical focus head 48, as shown, or they may be associated with the optical focus head 48 in some other way that allows for the three devices 48, 50, 52 to move in unison along the joint seam 38. The wire feeder 50 includes a guide spout 98 that feeds the filler wire 58 into the laser beam 54 along an axial feeding direction 100 (FIGS. 3 and 5) with the assistance of known precision guiding mechanical equipment and/or computer-aided control systems. The portion of the filler wire 58 that is fed into the laser beam 54—and is thus impinged and melted by the laser beam 54—is considered here to be the leading end 102 of the filler wire 58 (FIG. 5). The leading end 102 of the filler wire 58 has a length 104 measured along the axial feeding direction 100 of the filler wire 58. In terms of the shielding gas nozzle 52, it directs a flow of the shielding gas 60 towards the joint seam 38 so that the shielding gas zone 62 protects the leading end 102 of the filler wire 58 from oxidation and other forms of reactive contamination as the leading end 102 undergoes melting by the laser beam 54. The shielding gas gas 60 may be an inert gas, such as argon or helium, or it may be a mixture of gasses such as (i) argon and carbon dioxide or (ii) argon and oxygen.

The size and composition of the filler wire 58 may vary depending on the compositions of the first and second metal workpieces 12, 14 and other requirements of the braze joint 44. The filler wire 58 is constructed of a consumable filler material composition that has a melting point below the melting point of each of the first and second metal workpieces 12, 14. In this way, the filler wire 58 can be melted by the laser beam 54 without having to melt the first and second metal workpieces 12, 14. For example, when the first and second metal workpieces 12, 14 are steel workpieces, the filler wire 58 may have a diameter ranging from 0.6 mm to 1.8 mm and may be composed of any suitable consumable filler material composition including an alloy of copper, silicon, and manganese. Likewise, when when the first and second metal workpieces 12, 14 are aluminum alloy workpieces, the filler wire 58 may have a diameter ranging from 0.8 mm to 2.4 mm and may be composed of any suitable consumable filler material composition including an alloy of aluminum, silicon, and magnesium.

Referring now back to FIG. 1, the braze joint 44 is deposited within and along the joint seam 38 by advancing the laser beam 54 in a forward brazing direction 106 along the joint seam 38 while feeding the filler wire 58 into the laser beam 54 under the protection of the shielding gas zone 62. The energy of the laser beam 54 melts the leading end 102 of the filler wire 58 to produce molten filler material 108. This flowable molten filler material 108 is dispensed within and locally fills the joint seam 38 between the confronting regions 28′, 34′ of the first and second top surfaces 28, 34 of the first and second metal workpieces 12, 14. As the laser beam 54 is advanced along the joint seam 38, the filler wire 58 is fed continuously in the axial feeding direction 100 to maintain the impinged leading end 102 of the filler wire 58 within the laser beam 54 and, consequently, to ensure a continuous source of the flowable molten filler material 108 is available during advancement of the laser beam 54. The forward advancement of the laser beam 54 along the joint seam 38 in conjunction with the coordinated forward movement of the wire feeder 50, which is not only moving in unison with the laser brazing optical focusing head 48 but also controllably feeding the filler wire 58 into the advancing laser beam 54 at the same time, results in the molten filler material 108 being dispensed within and along the joint seam 38 between at least the confronting regions 28′, 34′ of the first and second top surfaces 28, 34 of the first and second metal workpieces 12, 14.

The wire feeder 50 may precede laser brazing optical focusing head 48 down the joint seam 38 such that the filler wire 58 is fed into the laser beam 54 in a direction opposite of the forward brazing direction 106. In other words, as shown best in FIGS. 3 and 6, the axial feeding direction 100 of the filler wire 58 may be opposed to the forward brazing direction 106 of the laser beam 54 as both the wire feeder 50 and the laser brazing optical focusing head 48 are conveyed relative to the metal workpiece assembly 10. Still further, and with reference to FIG. 3, the longitudinal beam axis 82 of the laser beam 54 may be tilted towards or away from the filler wire 58 so that the beam axis 82 is offset from normal in the forward brazing direction 106 (a “pulling” arrangement as shown by arrow 110) or offset from normal opposite the forward brazing direction 106 (a “pushing” arrangements shown by arrow 112). Other arrangements and orientations of the filler wire 58 and the laser beam 54 may of course be practiced. As for the positioning of the shielding gas nozzle 52, it may be oriented to direct the flow of the shielding gas 60 transverse to the forward brazing direction 106 as the laser beam 54 is advanced along the joint seam 38 and the molten filler material 108 is dispensed within and along the joint seam 38 behind the laser beam 54.

In accordance with practices of the disclosed method—and in an effort to better control the consistency and distribution of the molten filler material 108 within the joint seam 38 between the first and second metal workpieces 12, 14—relative movement between the laser beam 54 and the filler wire 58 may be implemented by repeatedly fluctuating the position of the focal point 80 of the laser beam 54 relative to the the filler wire 58 during advancement of the laser beam 54 along the joint seam 38. The repeated fluctuation in the position of the focal point 80 relative to the filler wire 58 encompass any recurring variances in the spatial orientation of the focal point 80 and the filler wire 58 including recurring changes in the distance between the two items 80, 58, recurring changes in the alignment between the two items 80, 58, recurring changes in the size of the leading end 102 of the filler wire 58, or any combination of those positional variances. In that regard, the repeated fluctuation of the position of the focal point 80 relative to the filler wire 58 can be accomplished by executing one or more of the following actions: (1) oscillating the focal point 80 of the laser beam 54 along the longitudinal beam axis 82 with respect to the metal workpiece assembly 10; (2) oscillating the filler wire 58 along a direction parallel to the axial feeding direction 100 of the filler wire 58; or (3) oscillating the filler wire 58 in a direction transverse to the axial feeding direction 100 of the filler wire 58.

Referring now to FIG. 3, the repeated fluctuation of the position of the focal point 80 relative to the filler wire 58 according to one embodiment is illustrated in which the focal point 80 of the laser beam 54 is oscillated along the longitudinal beam axis 82 with respect to the metal workpiece assembly 10. As shown, such oscillation of the focal point 80 alternately increases (line 114) and decreases (line 116) the focal distance 86 of the laser beam 54 during advancement of the laser beam 54 along the joint seam 38, which, in turn, increases and decreases the area of the beam spot 88, respectively. When the focal distance 86 is increased, thereby resulting in an increase in the area of the beam spot 88 and an increase in the distance between the focal point 80 and the leading end 102 of the filler wire 58, the power density of the laser beam 54 delivered to the filler wire 58 at its leading end 102 is decreased since the sectional area over which the power of the laser beam 54 is spread at the filler wire 58 is increased. Conversely, when the focal distance 86 is decreases, thereby resulting in a decrease in the area of the beam spot 88 and a decrease in the distance between the focal point 80 and the leading end 102 of the filler wire 58, the power density of the laser beam 54 delivered to the filler wire at its leading end 102 is increased since the sectional area over which the power of the laser beam 54 is spread at the filler wire 58 is decreased.

The focal point 80 of the laser beam 54 may be oscillated so that the focal distance 86 of the laser beam 54 is alternately increased and decreased over a total oscillation height 118 that ranges from 0.1 mm to 1.0 mm or, more narrowly, from 0.2 mm to 0.8 mm. The focal distance 84 is preferably oscillated over the total oscillation height 118 anywhere between a lower focal distance limit 120 and an upper focal distance limit 122. The lower focal distance limit 120 is preferably 0 mm (although it is shown greater than 0 mm in FIG. 3 for ease of illustration) and the upper focal distance limit 122 is preferably 10 mm away or, more preferably 5 mm away, from the plane 90 that establishes a focal distance of 0 mm in either direction. As such, the focal point 80 may be oscillated above the metal workpiece assembly 10 (i.e., between the metal workpiece assembly 10 and the laser brazing optical focusing head 48), below the metal workpiece assembly 10 (i.e., on the opposite side of the metal workpiece assembly 10 from the laser brazing optical focusing head 48), or the oscillations may extend above and below the plane 90 that sets the focal distance at 0 mm. Regardless of where exactly the focal point oscillations take place, the focal point 80 may be oscillated at a frequency that ranges from 2 Hz to 1000 Hz or, more narrowly, from 3 Hz to 100 Hz. And, while the oscillations of the focal point 80 preferably occur along the entire joint seam 38, in other embodiments the oscillations may occur over at least 50% of the joint seam 38 along which the laser beam 54 is advanced.

The focal point 80 of the laser beam 54 may be oscillated either mechanically or optically. The focal point 80 may be mechanically oscillated by a linear actuator 124 (FIG. 1) onto which the laser brazing optical focusing head 48 is mounted at the robot arm 96. The linear actuator 124 physically moves the laser brazing optical focusing head 48 up and down relative to the metal workpiece assembly 10, and may be servomotor driven or it may be driven hydraulically, pneumatically, piezoelectrically, or electrical-mechanically, to name but a few alternative drive mechanisms. In this scenario, the focal length 84 of the laser beam 54 remains constant while the focal distance 86 of the laser beam 86 is alternately increased and decreased in congruence with the upward and downward movement of the optical focusing head 48. The focal point 80 may be optically oscillated by operating the adaptive focusing optic assembly 94 to repeatedly vary the focal length 84 of the laser beam 54. In this scenario, the laser brazing optical focusing head 48 is conveyed above the metal workpiece assembly 10 in a smooth path while the adaptive optic lens assembly 94 constantly moves the focal point 80 so as to repeatedly vary the focal length 84 of the laser beam 54, which, consequently, alternately increases and decreases the focal distance 86 of the laser beam 54 to a corresponding yet opposite extent. The oscillations of the focal point 80, however accomplished, enable better control of the heating and melting of the filler wire 58 to help mitigate braze discrepancies such as skip pores and spatter.

Referring now to FIG. 5, the repeated fluctuation of the position of the focal point 80 relative to the filler wire 58 according to another embodiment is illustrated in which the filler wire 58 is oscillated along a direction 126 parallel to the axial feeding direction 100 of the filler wire 58. In this way, the length 104 of the leading end 102 of the filler wire 58 is alternately increased and decreased as the filler wire 58 is oscillated, or, in other words, the portion of the filler wire 58 that is impinged by the laser beam 54 is repetitively expanded and contracted. And, because the filler wire 58 is consumed via melting, the filler w ire 58 overall is continued to be fed into the laser beam 54 while the oscillations of the filler wire 58 are executed to ensure that molten filler material 108 is constantly being produced. Essentially, the feeding of the filler wire 58 into the laser beam 54 resembles more of a stuttering of forward movement in the axial feeding direction 100 as opposed to a constant linear feed. The oscillations of the filler wire 58 according to this practice may be mechanically driven at the wire feeder 50 and may alternately increase and decrease the length 104 of the leading end 102 of the filler wire 58 between 0.1 mm and 1.2 mm or, more narrowly, between 0.3 mm and 0.8 mm, at a frequency that ranges from 3 Hz to 1000 Hz or, more narrowly, from 20 Hz to 100 Hz. Like the oscillations of the focal point 80, the oscillations of the filler wire 58 according to this embodiment helps control of the heating and melting of the filler wire 58 and may occur over at least 50% of the joint seam 38, and preferably over the entire joint seam 38, along which the laser beam 54 is advanced.

Referring now to FIG. 6, the repeated fluctuation of the position of the focal point 80 relative to the filler wire 58 according to yet another embodiment is illustrated in which the filler wire 58 is oscillated in a direction 128 transverse to the axial feeding direction 100 of the filler wire 58. Such oscillations move the leading end 102 of the filler wire 58 back-and-forth across the centerline plane 40 of the joint seam 38 during advancement of the laser beam 54 along the joint seam 38, basically toggling the leading end 102 of the filler wire 58 between the confronting regions 28′, 34′ of the first and second top surfaces 28, 34 of the first and second metal workpieces 12, 14. The leading end 102 of the filler wire 58 may traverse a total distance 130 in the transverse direction 128 that ranges from 0.1 mm to 2.0 mm or, more narrowly, from 0.3 mm to 1.2 mm. And the frequency of the oscillations of the filler wire 58 in the transverse direction 128 may range from 2 Hz to 1500 Hz or, more narrowly, from 3 Hz to 100 Hz. The oscillations of the filler wire 58 according to this practice may be mechanically driven at the wire feeder 50 and may occur over at least 50% of the joint seam 38, and preferably over the entire joint seam 38, along which the laser beam 54 is advanced. The oscillations of the filler wire 58 according to this embodiment promote better dispersal of the molten filler material XX within the joint seam 38 and, thus, better wetting of the first and second metal workpieces 12, 14.

In one particular implementation of the disclosed laser brazing method, the focal point 80 of the laser beam 54 may be oscillated to alternately increase and decrease the focal distance 86 of the laser beam 54, as illustrated in FIG. 3, while at the same time the filler wire 58 is oscillated to move the leading end 102 of the filler wire 58 back-and-forth across the centerline plane 40 of the joint seam 38, as illustrated in FIG. 6, during advancement of the laser beam 54 along at least part of the joint seam 38. In that regard, the filler wire 58 can be heated and melted at a more controlled rate and the molten filler material 108 can be simultaneously spread across the joint seam 38 to achieve broad wetting and good contact between the molten filler material 108 and the confronting regions 28′, 34′ of the first and second top surfaces 28, 34 of the first and second metal workpieces 12, 14. Contemporaneously implementing these two forms of relative movement between the focal point 80 of the laser beam 54 and the leading end 102 of the filler wire 58 provides the most effective way to melt and dispense the molten filler material 108 within and along the joint seam 38 during advancement of the laser beam 54 along the joint seam 38, at least in terms of mitigating braze discrepancies and promoting good wetting behavior of the molten filler material 108 on both the metal workpieces 12, 14.

The molten filler material 108 that is dispensed within the joint seam 38 in the wake of the forward advancement of the laser beam 54 wets at least the confronting regions 28′, 34′ of the first and second top surfaces 28, 34 of the first and second metal workpieces 12, 14 and eventually solidifies into the braze joint 44 that joins the first and second metal workpieces 12, 14 together. The joining of the first and second metal workpieces 12, 14 may be accomplished by a metallurgical bond. The braze joint 44 has a top surface 132 that extends between the first top surface 28 of the first metal workpiece 12 and the second top surface 34 of the second metal workpiece 14 across the joint seam 38 to unify the two top surfaces 28, 34 into the conjoint upper surface 42 of the metal workpiece assembly 10. The conjoint upper surface 42 may now be further processed. For example, the conjoint upper surface 42 may be smoothed by any suitable technique, such as buffering, brushing, or sanding, particularly in the area of the top surface 132 of the braze joint 44, and may then be painted to give the appearance of a singular unitary surface as opposed to two surfaces that have been joined together. This type of further processing is often practiced when the conjoint upper surface 42 is required to exhibit a Class A or show surface quality because it is intended to constitute part of an exterior surface of a vehicle or other manufactured article where visual appearance is a component of overall part quality.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A method of laser brazing a metal workpiece assembly, the method comprising:
providing a metal workpiece assembly that includes a first metal workpiece and a second metal workpiece, the first and second metal workpieces establishing a joint seam;
advancing a laser beam along the joint seam while feeding a filler wire into the laser beam to melt a leading end of the filler wire, which is impinged by the laser beam, to produce and dispense molten filler material within and along the joint seam as the laser beam is advanced along the joint seam, the molten filler material solidifying behind the laser beam into a braze joint; and
repeatedly fluctuating a position of a focal point of the laser beam relative to the filler wire during advancement of the laser beam along at least part of the joint seam.

2. The method set forth in claim 1, wherein repeatedly fluctuating the position of the focal point of the laser beam relative to the filler wire comprises oscillating the focal point along a longitudinal beam axis of the laser beam to thereby alternately increase and decrease a focal distance of the laser beam during advancement of the laser beam along the joint seam.

3. The method set forth claim 2, wherein the focal point of the laser beam is oscillated so that the focal distance of the laser beam is alternately increased and decreased over a total oscillation height between 0.1 mm and 1.0 mm at a frequency of 2 Hz to 1000 Hz.

4. The method set forth in claim 1, wherein repeatedly fluctuating the position of the focal point of the laser beam relative to the filler wire comprises oscillating the filler wire along a direction parallel to an axial feeding direction of the filler wire to alternately increase and decrease a length of the leading end of the filler wire during advancement of the laser beam along the joint seam.

5. The method set forth in claim 4, wherein the filler wire is oscillated so that the length of the filler wire is alternately increased and decreased within a length range of 0.1 mm to 0.8 mm at a frequency of 3 Hz to 1000 Hz.

6. The method set forth in claim 1, wherein repeatedly fluctuating the position of the focal point of the laser beam relative to the filler wire comprises oscillating the filler wire along a direction transverse to an axial feeding direction of the filler wire to move the leading end of the filler wire back-and-forth across a centerline plane of the joint seam during advancement of the laser beam along the joint seam.

7. The method set forth in claim 6, wherein the filler wire is oscillated so that the leading end of the filler wire is moved across the centerline plane of the joint seam over a distance that ranges from 0.1 mm to 2.0 mm at a frequency of 2 Hz to 1500 Hz.

8. The method set forth in claim 1, wherein each of the first metal workpiece and the second metal workpiece is a steel workpiece.

9. The method set forth in claim 8, wherein at least one of the first metal workpiece or the second metal workpiece is a steel workpiece that comprises a surface coating comprised of a zinc-based coating material or an aluminum-based coating material.

10. The method set forth in claim 1, wherein each of the first metal workpiece and the second metal workpiece is an aluminum alloy workpiece.

11. The method set forth in claim 10, wherein at least one of the first metal workpiece or the second metal workpiece is an aluminum alloy workpiece that comprises a surface coating comprised of a refractory oxide material.

12. A method of laser brazing a metal workpiece assembly, the method comprising:
advancing a laser beam along a joint seam established between a first metal workpiece and a second metal workpiece of a metal workpiece assembly, the laser beam having a focal point;
feeding a filler wire into the laser beam as the laser beam is being advanced along the joint seam to melt a leading end of the filler wire, which is impinged by the laser beam, to produce and dispense molten filler material within and along the joint seam; and
repeatedly fluctuating a position of the focal point of the laser beam relative to the filler wire during advancement of the laser beam along at least part of the joint seam, the molten filler material solidifying behind the laser beam into a braze joint that metallurgically bonds the first and second metal workpieces together.

13. The method set forth in claim 12, wherein repeatedly fluctuating the position of the focal point of the laser beam relative to the filler wire comprises oscillating the focal point along a longitudinal beam axis of the laser beam to thereby alternately increase and decrease a focal distance of the laser beam during advancement of the laser beam along the joint seam.

14. The method set forth in claim 12, wherein repeatedly fluctuating the position of the focal point of the laser beam relative to the filler wire comprises oscillating the filler wire along a direction parallel to an axial feeding direction of the filler wire to alternately increase and decrease a length of the leading end of the filler wire during advancement of the laser beam along the joint seam.

15. The method set forth in claim 12, wherein repeatedly fluctuating the position of the focal point of the laser beam relative to the filler wire comprises oscillating the filler wire along a direction transverse to an axial feeding direction of the filler wire to move the leading end of the filler wire back-and-forth across a centerline plane of the joint seam during advancement of the laser beam along the joint seam.

16. The method set forth in claim 12, wherein each of the first metal workpiece and the second metal workpiece is a steel workpiece, and wherein at least one of the first metal workpiece or the second metal workpiece comprises a surface coating comprised of a zinc-based coating material.

17. The method set forth in claim 12, wherein each of the first metal workpiece and the second metal workpiece is an aluminum alloy workpiece, and wherein at least one of the first metal workpiece or the second metal workpiece comprises a surface coating comprised of a refractory oxide material.

18. The A method of laser brazing a metal workpiece assembly, the method comprising:
advancing a laser beam along a joint seam established between a first metal workpiece and a second metal workpiece of a metal workpiece assembly, the laser beam having a focal point;
feeding a filler wire into the laser beam as the laser beam is being advanced along the joint seam to melt a leading end of the filler wire, which is impinged by the laser beam, to produce and dispense molten filler material within and along the joint seam, the molten filler material solidifying behind the laser beam into a braze joint that metallurgically bonds the first and second metal workpieces together;
oscillating the focal point of the laser beam along a longitudinal beam axis of the laser beam to thereby alternately increase and decrease a focal distance of the laser beam during advancement of the laser beam along at least part of the joint seam; and
oscillating the filler wire along a direction transverse to an axial feeding direction of the filler wire to move the leading end of the filler wire back-and-forth across a centerline plane of the joint seam during advancement of the laser beam along at least part of the joint seam at the same time the focal point of the laser beam is being oscillated along the longitudinal beam axis of the laser beam.
